(19) United States
(12) Patent Application Publication
(10) Pub. No.: US 2010/0127695 A1
(43) Pub. Date: May 27, 2010

(54) INDUCTIVE SENSORS

(76) Inventor: Ian HARRIS, Poole, Dorset (GB)

Correspondence Address: GOTTLIEB RACKMAN & REISMAN PC, 270 MADISON AVENUE, 8TH FLOOR, NEW YORK, NY, 10016-0601, US

(21) Appl. No.: 12/596,246

(22) PCT Filed: Apr. 15, 2008
(86) PCT No.: PCT/GB2008/001318

§ 371 Date: Dec. 3, 2009

(30) Foreign Application Priority Data
Apr. 17, 2007 (GB) 0707376.0

(51) Int. Cl. G01B 7/14

(52) U.S. Cl. 324/207.16

(57) ABSTRACT

An inductive sensor is operable for detecting a relative position of, or movement between, a member and at least one inductor. An electrical parameter associated with the inductor is caused to change as a result of a change of inductive coupling in response to a change in relative position of the inductor and the member. The sensor further comprises means for setting a datum value of the electrical parameter. The setting means comprises a component that is moveable so as to adjust the inductive coupling while the member is in a datum position.

The present invention relates to inductive sensors. More particularly, the invention relates to sensors that detect position or movement by means of electromagnetic induction.

Inductive sensors are used widely, for example, in the control or measurement of position in systems such as fuel flow measurement, servo valves or hydraulic actuators. Examples of inductive sensors include linear variable differential transducers (LVDTs), linear variable inductive transducers (LVIT), variable resistive vector sensors and eddy-current sensors. These sensors make use of inductive coupling to accurately detect the position and/or movement of a component. For example, on aircraft, hydraulic systems are used for actuating wing flaps and thrust reversers. In these sensors, a moveable member is coupled to the component and its movement relative to a fixed member or body results in a change in inductive coupling, which is detected by a change in an electrical parameter (e.g. voltage, current or impedance) of an inductor. In an inductive sensor such as an LVDT a signal (e.g. ac current) is supplied to a primary inductor winding, and the position of the moveable member determines the current induced in a secondary winding. In an eddy-current sensor; an inductor winding induces an eddy-current in a conductor (which may be part of the fixed or the moveable member of the sensor). The eddy current induced affects the impedance of the inductor winding, which varies in dependence on the relative positions of the inductor and the conductor.

In certain applications, such as in aircraft control systems, the sensor is required to monitor the position of a component with a high degree of accuracy. However, the components themselves and those to which they are mounted, are constructed to combined tolerances that may be well in excess of the required accuracy of the sensor/system. This means that when the sensor is fitted, its position must be carefully adjusted (for example by inserting shims into a flange mounting) so that a zero, or datum position corresponds to a zero or predetermined output signal from the sensor. This adjustment can be a time-consuming operation. Moreover, where the sensor is being used on a pressurised hydraulic or fuel system, the system must be depressurised before any adjustment is made to the sensor position.

The present invention has been conceived with the foregoing in mind.

According to a first aspect of the present invention there is provided an inductive sensor operable for detecting a relative position of, or movement between, a member and at least one inductor, wherein an electrical parameter associated with the inductor is caused to change as a result of a change of inductive coupling in response to a change in relative position of the inductor and the member, wherein the sensor further comprises means for setting a datum value of said electrical parameter, said setting means comprising a component that is moveable so as to adjust the inductive coupling while the member is in a datum position.

It is an advantage that the datum can be set by adjustment of the moveable component after the sensor has been mounted and without the need to move the sensor. This also means that adjustments can be made to a sensor on a pressurised system without the need for any depressurisation.

In embodiments of the invention the sensor is a LVDT. The LVDT may comprise a primary winding and at least one secondary winding, arranged around an axial passage, and wherein the member comprises a core of a magnetically permeable material for effecting inductive coupling when a current is applied to the primary winding so as to induce a current in the secondary winding. The moveable component may comprise a magnetically permeable portion that is moveable at least partially into the axial passage.

Preferably, the primary and secondary windings together define spatially an inductive region, and the magnetically permeable portion has a discrete length, which is moveable wholly within the inductive region. It is an advantage that because the permeable portion is wholly contained within the inductive region, its movement will adjust a zero off-set without noticeably or substantially affecting the gain of the sensor. Alternatively, the magnetically permeable portion may be moveable such that a variable length of the magnetically permeable portion extends into the inductive region. In that case, both the off-set and the gain will be changed by movement of the permeable portion.

It will be appreciated that the position of the moveable component will affect the induced voltage in the secondary windings. However, depending on how the sensor is configured, it may not be the induced voltage that is actually measured. For example, some sensors employ a half bridge circuit, in which the impedances of the secondary windings determine the output voltage for the sensor circuit. In such cases, the impedances of the windings are affected by the position of the moveable component, which can be used to adjust the winding output at the datum position. In some sensors, movement of the moveable component may alter the inductance or resistive vector depending upon how the sensor is being operated or interrogated by the measurement circuitry. Thus, the term “inductive coupling” will be understood to cover a wide variety of ways in which the movement of the moveable component may be used to adjust the datum setting, and is not limited to sensors that operate by measurement of an induced voltage or current.

The LVDT may comprise first and second secondary windings arranged around said axial passage, wherein the electrical parameter comprises a voltage or current induced in one, or both of said secondary windings, or a ratio of said voltages/currents. The first and second secondary windings may be arranged to provide a ratio of turns that varies linearly in the axial direction.

In other embodiments the sensor is an eddy-current sensor. The inductor may comprise a winding and the sensor may further comprise a conductive member, whereby an ac current applied to the inductor winding generates an eddy-current in the conductive member such that the impedance of the inductor winding is dependent on the relative positions of the inductor winding and the conductive member. The moveable component may be a further conductive member in which an eddy current is generated.

In one embodiment, the inductor winding is carried on the moveable member, the conductive member being a sleeve, surrounding an axial passage along which the moveable member is moveable. Preferably, the moveable component is a conductive ring.

In one embodiment the inductor winding is a stationary winding, the conductive member being moveable relative thereto.

According to a second aspect of the present invention there is provided a method for setting a datum for an inductive sensor operable for detecting a relative position of, or movement between, a member and at least one inductor, wherein an electrical parameter associated with the inductor is caused to change as a result of a change of inductive coupling in response to a change in relative position of the inductor and the member, the method comprising: mounting said sensor in an operating location such that said member is in a datum position relative to said inductor; monitoring said electrical parameter; and moving an adjustment piece so as to alter the inductive coupling to adjust said electrical parameter to a datum value, while said member is in said datum position with the sensor mounted in the operating location.

Embodiments of the invention will now be described with reference to the accompanying drawings in which:

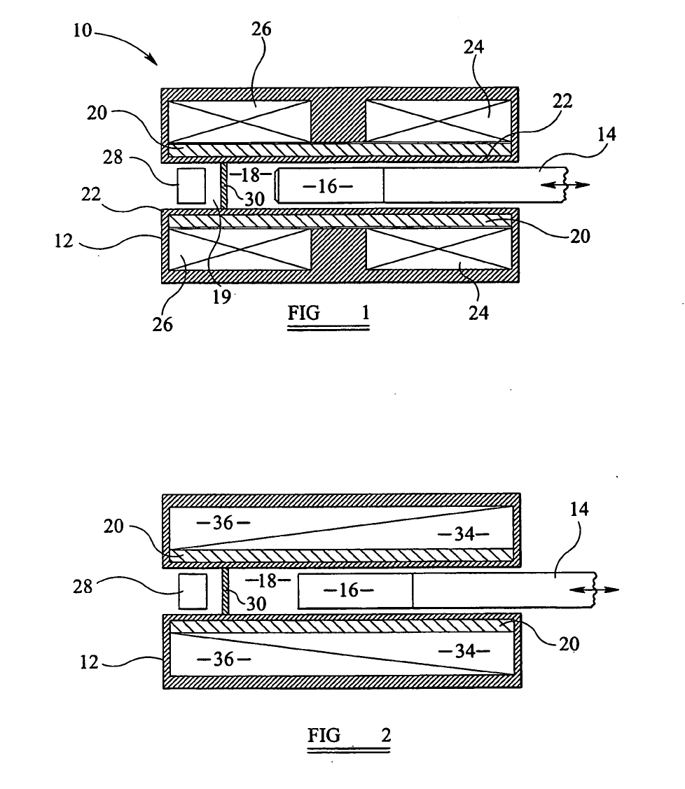

FIG. 1 is a cross-sectional view of an LVDT;

FIG. 2 is a cross-sectional view of another LVDT;

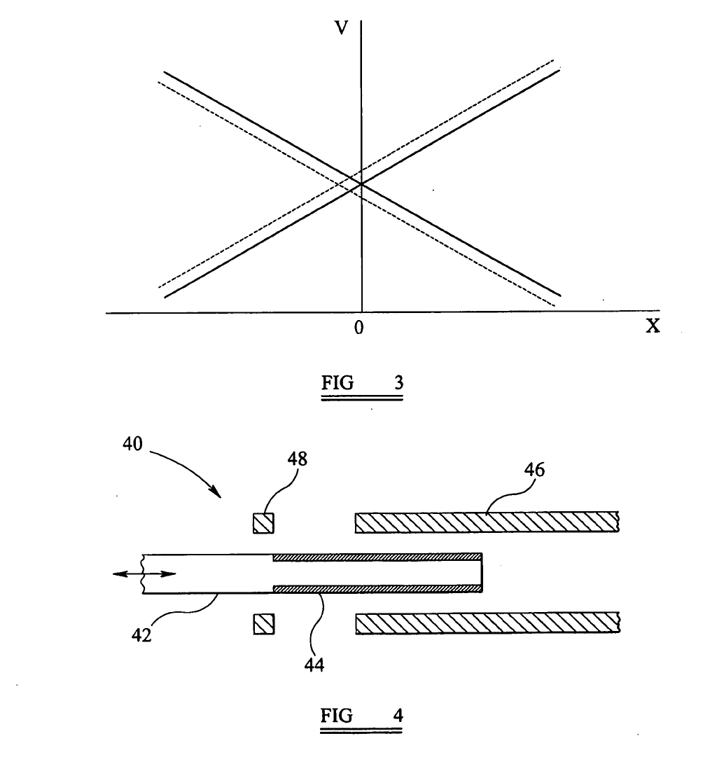

FIG. 3 is a graph showing induced voltage as a function of a component position for the LVDT of FIG. 2; and

FIG. 4 is an illustration depicting the principal components of an eddy-current sensor.

Referring to FIG. 1, an LVDT has a body 12 and a moveable member 14. The moveable member 14 carries a core 16 of a magnetically permeable material. The member and core are moveable longitudinally within an axial passage 18 formed in the body 12. The body 12 carries a primary winding 20 consisting of a conductive wire coiled around the outside of an inner wall 22, the inside of which defines the bore of the axial passage 18. The primary winding 20 extends substantially the entire length of the body 12. A first secondary winding 24 comprises a conductive wire wound around a first portion of the length of the body 12 and a second secondary winding 26 comprises another conductive wire wound around a second portion of the length of the body 12.

When an ac current is supplied to the primary winding 20, this generates a magnetic field. The magnetic field will induce a current to flow in the secondary windings 24, 26. The size of the current induced in each of the secondary windings 24, 26 will vary in accordance with the amount of magnetic coupling, which will depend on the position of the magnetically permeable core 16. When the core 16 is moved, the relative sizes of the currents induced in each of the secondary windings 24, 26 will change. Measurements of these induced currents, or the voltages across each of the secondary windings 24, 26 can be used to provide an accurate measurement of the position of the core 16 and moveable member 14. For example, in a hydraulic system, an LVDT such as that described may be used to measure the position of an hydraulic actuator. A signal provided by the LVDT may then be used for controlling the actuator.

When the moveable member 14 is in a central position, such as that shown in FIG. 1, the currents induced in each of the secondary windings will be similar. These may be combined, using suitable circuitry, to cancel each other and thereby provide a zero current (or voltage) output that corresponds to this position. However, the LVDT is required to be mounted such that the body 12 is fixedly attached to one component (e.g. hydraulic cylinder), while the moveable member 14 is attached to another component (e.g. piston). Such mechanical components are manufactured to within certain tolerances, and these tolerances mean that, when the LVDT is mounted, it cannot be guaranteed that the zero output position exactly corresponds to the zero, or datum position of the component. Accordingly, when such systems are being assembled it has hitherto been necessary for some physical adjustment to be made to the mounting of the LVDT. This can be a difficult an time consuming operation, especially if the LVDT is to be adjusted after some time in service or if the passage 18 and space surrounding the moveable member 14 is pressurised with fuel or hydraulic fluid. Moreover, certain applications require such position sensors to indicate position to an accuracy that is less than the size tolerances of the components to which they are mounted.

To overcome these difficulties, in accordance with the present invention, means are provided for setting a datum. As shown in FIG. 1, an adjustment component is provided in the form of an adjustment piece 28 of magnetically permeable material. The axial passage 18 is blocked off with a wall 30 so that pressurised fluid is contained in the axial passage 18 to the right of the wall 30, as shown in FIG. 1. The adjustment piece 28 is axially moveable within a portion 19 of the axial passage that lies to the left of the wall 30. The amount of magnetic coupling between the primary winding 20 and the second secondary winding 26 can be adjusted by moving the adjustment piece 28 further into or out of the passage portion 19. However, movement of the adjustment piece 28 has very little effect on the magnetic coupling between the primary winding 20 and the first secondary winding 24.

Accordingly, when setting up or adjusting the LVDT, the component (e.g. piston) to which the moveable member 14 is mounted is moved to the datum position. The output signal from the LVDT 10 is then measured, and the adjustment piece 28 moved until the output signal indicated is zero (or some other predetermined required value). Various means may be provided for moving the adjustment piece 28, for example the adjustment piece 28 may be carried on a screw threaded member (not shown) that engages a corresponding thread on the body 12 of the LVDT. Alternatively, the adjustment piece may be a screw-threaded, or otherwise moveable, member that can be screwed or moved in/out such that a greater/lesser extent penetrates the axial passage portion 19. It will be appreciated that the adjustment piece 28 must then remain in the set position and means may be provided for securing or locking the adjustment piece 28 to the body 12.

The presence of the wall 30 allows the moveable member 14 and core 16 to be contained in a sealed, pressurised zone, while the adjustment piece 28 can be moved to set a datum for the sensor, without the need to remove the sensor from its mounting or to de-pressurise the system. It will be appreciated that the wall 30 would not be required in applications where it is not necessary to contain the moveable member 14 inside a sealed or pressurised environment.

FIG. 2 depicts an alternative arrangement for an LVDT 30, similar to the LVDT 10 of FIG. 1. Equivalent features have the same reference numerals. The principle difference is that in FIG. 2 the secondary windings are first and second tapered secondary windings 34, 36. In this arrangement, the ratio of the number of turns of the first secondary winding 34 to the number of turns of the second secondary winding 36 varies linearly along the length of the LVDT 30. At the mid-point of the windings the ratio is 1:1. Thus, when the core 16 is located at a central position in the axial passage 18, the current induced in each of the secondary windings 34, 36 will be the same. As with the LVDT 10 of FIG. 1, a datum position can be adjusted by moving the axial position of the adjustment piece 28.

FIG. 3, is a graph showing the voltage induced in each of the secondary windings , 34, 36 of FIG. 2 as a function of the position, x of a component to which the sensor is mounted. The solid lines show the required induced voltages, which should be the same when x=0. In other words, when x=0, the core 16 should be located at the central position so as to induce the same voltage in each of the secondary windings. However, due to the tolerances of the components, when the sensor is mounted, it is found that the core 16 is not at the central position, but is displaced a small distance when the component is at x=0. As a consequence the induced voltages in the secondary windings 34, 36 are shown by the dashed lines. Now, the adjustment piece 28 can be moved to adjust the induced voltages in the secondary windings, to bring them back to the solid lines, without having to move the sensor on its mounting. Note that the gradients of the solid and dashed lines shown in FIG. 3 do not change. This is because the gain of the sensor does not change when the adjustment is made. This occurs when the adjustment piece 28, or the magnetically permeable portion thereof, is wholly within the inductive region of the sensor. If the magnetically permeable adjustment piece 28 extends outside the inductive region, such that its movement resulted in a variable length of permeable material extending into the inductive region, then the zero off-set could still be adjusted, but the gain (gradients of the lines in FIG. 3) would also change.

FIG. 4 illustrates the principles of the invention in relation to an eddy-current sensor 40. A moveable member 42 is mounted to a component (not shown) and can move along an axis in response to movement of the component. The moveable member 42 carries an inductor winding 44, which is supplied with a high frequency ac signal. A sleeve 46 of a conductive material (low resistivity) surrounds the axis such that the movement of the moveable member penetrates the space inside the sleeve 46 to a variable extent. The high frequency ac signal induces an eddy-current in the conductive sleeve material. The amount of eddy-current induced depends on the extent to which the inductor winding 44 penetrates the sleeve 46. The effect of the inductive coupling between the inductor and the induced eddy current in the sleeve 46 is to alter the impedance of the inductor, which can be detected using a suitable circuit (not shown), to provide an output signal indicative of the relative position of the moveable member 42 and the sleeve 46.

The same problems exist for this type of sensor as described above for the LVDT 10 regarding the required accuracy and setting of a datum when the sensor is mounted. In accordance with the invention, an adjustment piece 48 is provided to allow a datum to be set. In this case the adjustment piece 48 is in the form of a ring of conductive material that can be moved axially. As with the sleeve 46, an eddy current is induced in the ring 48. The amount of eddy current induced in the ring 48 is small compared with that induced in the sleeve and depends on the position of the ring 48 relative to the inductor winding 44. Thus, the value of the impedance of the inductor winding 44 can be adjusted by moving the ring 44 to provide the required value at a set datum position.

It will be appreciated that, in the embodiments described above, while one member is described as a moveable member, the principles of the invention would work equally well with that member in a fixed position, and the other parts of the sensor being moved. The principles of these inductive sensors only require movement of one part relative to the others.

1. An inductive sensor operable for detecting a relative position of, or movement between, a member and at least one inductor, wherein an electrical parameter associated with the inductor is caused to change as a result of a change of inductive coupling in response to a change in relative position of the inductor and the member,
wherein the sensor further comprises means for setting a datum value of said electrical parameter, said setting means comprising a component that is moveable so as to adjust the inductive coupling while the member is in a datum position.

2. An inductive sensor according to claim 1, wherein the sensor is a LVDT.

3. An inductive sensor according to claim 2 wherein the LVDT comprises a primary winding and at least one secondary winding, arranged around an axial passage, and wherein the member comprises a core of a magnetically permeable material for effecting inductive coupling when a current is applied to the primary winding so as to induce a current in the secondary winding.

4. An inductive sensor according to claim 3, wherein the moveable component comprises a magnetically permeable portion that is moveable at least partially into said axial passage.

5. An inductive sensor according to claim 4, wherein the primary and secondary windings together define spatially an inductive region, and the magnetically permeable portion has a discrete length, which is moveable wholly within the inductive region.

6. An inductive sensor according to claim 4, wherein the magnetically permeable portion is moveable such that a variable length of the magnetically permeable portion extends into the inductive region.

7. An inductive sensor according to any of claims 3 to 6, wherein the LVDT comprises first and second secondary windings arranged around said axial passage, and wherein the electrical parameter comprises a voltage or current induced in one, or both of said secondary windings, or a ratio of said voltages/currents.

8. An inductive sensor according to claim 7 wherein the first and second secondary windings are arranged to provide a ratio of turns that varies linearly in the axial direction.

9. An inductive sensor according to claim 1 wherein the sensor is an eddy-current sensor.

10. An inductive sensor according to claim 9, wherein the inductor comprises a winding and the sensor further comprises a conductive member, whereby an ac current applied to the inductor winding generates an eddy-current in the conductive member such that the impedance of the inductor winding is dependent on the relative positions of the inductor winding and the conductive member, and wherein the moveable component is further conductive member in which an eddy current is generated.

11. An inductive sensor according to claim 10, wherein the inductor winding is carried on the moveable member, the conductive member being a sleeve, surrounding an axial passage along which the moveable member is moveable.

12. An inductive sensor according to claim 11, wherein the moveable component is a conductive ring.

13. An inductive sensor according to claim 10, wherein the inductor winding is a stationary winding, the conductive member being moveable relative thereto.

14. A method for setting a datum for an inductive sensor operable for detecting a relative position of, or movement between, a member and at least one inductor, wherein an electrical parameter associated with the inductor is caused to change as a result of a change of inductive coupling in response to a change in relative position of the inductor and the member, the method comprising:
mounting said sensor in an operating location such that said member is in a datum position relative to said inductor;
monitoring said electrical parameter; and
moving an adjustment piece so as to alter the inductive coupling to adjust said electrical parameter to a datum value, while said member is in said datum position with the sensor mounted in the operating location.
